(19) United States
(12) Patent Application Publication
(10) Pub. No.: US 2016/0195216 A1
(43) Pub. Date: Jul. 7, 2016

(54) OUTER COATING FOR AN UNDERGROUND PIPING MEMBER MADE FROM IRON, COATED PIPING MEMBER AND METHOD FOR DEPOSITING THE COATING

(71) Applicant: SAINT GOBAIN PAM, Pont-à-Mousson (FR)

(72) Inventors: Olivier BONDIL, PONT-A-MOUSSON (FR); Gérard NOUAIL, METZ (FR); Jean-Marc PEDEUTOUR, BLENOD LES PONT A MOUSSON (FR)

(21) Appl. No.: 14/916,169

(22) PCT Filed: Aug. 19, 2014
(86) PCT No.: PCT/EP2014/067693

§ 371 Date: Mar. 2, 2016

(30) Foreign Application Priority Data
Sep. 2, 2013 (FR) 1358364

(51) Int. Cl. F16L 58/10; F16L 58/08; C23C 4/06

(52) U.S. Cl. CPC F16L 58/1054; C23C 4/06; F16L 58/08

(57) ABSTRACT

The invention relates to an outer coating (9) for an underground piping member (7) made from iron, in particular cast iron, the outer coating comprising a first porous layer (11) and a second porous layer (13) positioned on the first layer and capable of plugging the pores of the first layer (11). The first layer comprises substantially pure zinc or an alloy or pseudo-alloy of zinc, the alloy or pseudo-alloy comprising at least 50 wt % zinc, and preferably between 0.5 wt % and 40 wt % aluminum. The second layer comprises a paint with a base of at least one organic resin, the paint being either single-component in an organic solvent or co-solvent, or dual-component. At least one among the first layer and second layer comprises a bactericidal agent.

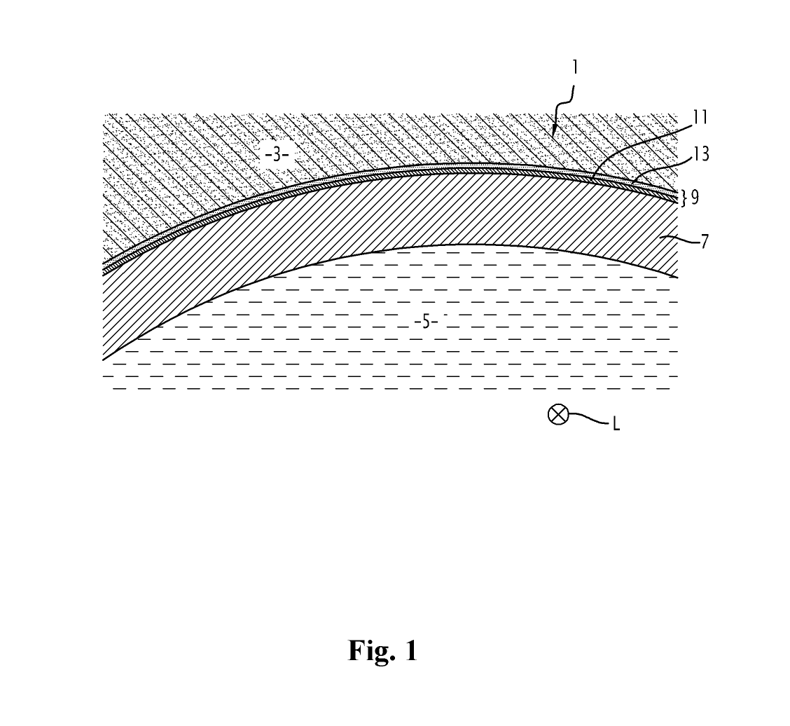

The invention also relates to a corresponding coated piping member and method for depositing the coating.

The present invention relates to an outer coating for an underground piping member made from iron, in particular cast iron, the outer coating comprising a first porous layer and a second porous layer positioned on the first layer and capable of plugging the pores of the first layer.

The invention also relates to a piping member coated with this outer coating, as well as a method for depositing the coating on the piping member.

“Piping member” refers to pipes, as well as various accessories such as elbows, connectors, etc., for example used in the waterworks field.

Document JP-A-23010357 teaches a method for manufacturing a steel tube coating. This document considers spray deposition of a sacrificial zinc/aluminum alloy, followed by the deposition of an epoxy resin. It appears that the layer of resin must be tight. This method applies to tube coatings in a “drying area”, and therefore certainly aerial tubes, made from iron or steel.

Soil corrosion of ferrous metals is a phenomenon that differs from atmospheric corrosion through the mechanisms involved and the factors that govern it, in particular the creation of oxidation areas electrically associated with reduction areas that may be situated at a certain distance. This creates significant localized deteriorations of the ferrous metal. Furthermore, certain bacteria, in particular sulfate-reducing bacteria, locally present in certain soils, may intensify this electrochemical process. This is referred to as “bio-corrosion”.

Corrosion protection for underground piping members is thus faced with a particular difficulty, especially when the land is heterogeneous and of quite varied natures; the piping members, depending on their use, convey fluids of different temperatures, modifying the corrosion conditions; and the handling of the piping members designed to be buried frequently leads to injury at various locations of their outer surface.

Document EP-A-0 686 246 describes a piping member made from ductile cast iron including a coating comprising a first porous metallized layer and a second layer of paint providing a “pore plugging” effect. This coating provides effective and lasting protection of the pipe against corrosion, once it is buried.

One aim of the invention is to provide a coating providing more complete corrosion protection for the piping member, in particular in corrosive soil in the presence of sulfate-reducing bacteria, and at a competitive cost.

To that end, the invention relates to an outer coating of the type described above, wherein:
the first layer comprises substantially pure zinc or an alloy or pseudo-alloy of zinc, the alloy or pseudo-alloy comprising at least 50 wt % zinc, and preferably between 0.5 wt % and 40 wt % aluminum, and
the second layer comprises a paint with a base of at least one organic resin, the paint being either single-component in an organic solvent or co-solvent, or dual-component, and
at least one among the first and second layer comprises a bactericidal agent.

The expression “with a base of at least one organic resin” means that the paint includes at least one organic resin. For example, the organic resin represents at least 20 wt %, preferably at least 25 wt %, of the paint.

According to specific embodiments, the outer coating comprises one or more of the following features, considered alone or according to all technically possible combinations:
the paint is dual-component with solvent;
said solvent is organic;
said solvent is aqueous;
the paint is dual-component in aqueous phase with organic co-solvent;
the paint is dual-component with no solvent;
the first layer comprises at least one bactericidal agent taken from the list consisting of copper, silver, and a mixture of copper and silver, said copper, said silver, and said mixture of copper and silver respectively being at concentrations comprised between 0.1 wt % and 5 wt %, preferably between 0.5 wt % and 3 wt %;
the second layer comprises at least one bactericidal agent capable of coming into contact with water intended for human consumption, in particular copper, silver, or salts thereof, said copper, silver and salts thereof preferably respectively being at concentrations comprised between 0.1 wt % and 5 wt %;
the first layer has a surface density of at least 200 g/m², preferably at least 350 g/m²;
the second layer has a thickness advantageously comprised between 60 μm and 150 μm when dry;
the organic resin of the second layer is chosen from among acrylic, epoxide, polyurethane, bituminous, vinyl resins and mixtures thereof; and
the paint contains a solvent chosen from among organic solvents, water, and mixtures thereof, the solvent representing between 20 wt % and 60 wt %, preferably between 30 wt % and 50 wt %, of the paint, and the organic resin representing between 20 wt % and 70 wt %, preferably between 25 wt % and 45 wt %, of the paint.

The invention also relates to a coated piping member made from iron, in particular cast iron, designed to be buried, comprising an outer coating as described above.

The invention lastly relates to a method for depositing an outer coating as described above on a piping member made from iron, in particular cast iron, designed to be buried, the method comprising the following steps:

a) deposition of the first layer on the piping by metallization, preferably electric arc metallization, and

b) deposition on the first layer, not covered with white efflorescences, of the second layer.

According to specific embodiments, the method comprises one or more of the following features, considered alone or according to all technically possible combinations:
step b) for depositing the second layer is done by gun, and/or using a brush or roller, such that the second layer has a thickness comprised between 60 μm and 150 μm when dry;
step b) for depositing the second layer is at least partially done by gun with no compressed air, the application done by gun being performed on a surface having a temperature comprised between 35° C. and 80° C.;
in step b), said surface is brought to the temperature comprised between 35° C. and 80° C. by passing at least part of the piping member in a preheating oven;
in step a), the first layer is deposited by heat projection, preferably by electric arc;
step b) for depositing the second layer is done by gun with compressed air;
step b) for depositing the second layer is done by gun without compressed air.

The invention will be better understood upon reading the following description, provided solely as an example, and done in reference to the sole FIGURE, which is a partial diagrammatic view of a cross-section of a piping member according to the invention.

The FIGURE shows a coated piping member 1 buried in the ground 3 and used to convey a fluid 5, for example drinking water.

The coated piping member 1 comprises a piping member 7 and an outer coating 9 situated between the ground 3 and the piping member 7, advantageously distributed over the piping member 7 so as to isolate it from the ground 3.

The piping member 7 is made from iron, advantageously ductile cast iron. The piping member 7 is for example a pipe. In the illustrated example, it extends in a longitudinal direction L perpendicular to the plane of the FIGURE. Only one portion of the section of the piping member 7 is shown in the FIGURE, the rest of the section being able to be extrapolated easily from the illustrated portion.

The fluid 5 circulates inside the piping member 7 in the longitudinal direction L. An inner coating, not shown, may exist on an inner wall of the piping member 7, to isolate the fluid 5 from the piping member 7.

The outer coating 9 comprises a first layer 11 and a second layer 13 positioned on the first layer 11.

The first layer 11 is porous and advantageously deposited by electric arc metallization. The first layer 11 comprises substantially pure zinc, or an alloy or pseudo-alloy of zinc.

The first layer 11 also comprises copper and/or silver, in content levels comprised between 0.1 wt % and 5 wt %. These components are for example added in elementary form, or in oxide form.

The alloy or pseudo-alloy comprises at least 50 wt % of zinc, and between 0.5 wt % and 40 wt % of aluminum. For example, the first layer 11 comprises 84 wt % of zinc, 15 wt % of aluminum and 1 wt % of copper.

Under the action of the corrosive agents from the ground, the first layer 11 turns into a protective layer of stable corrosion products in the environment where it was created. The first layer 11 is thus called “anodic” relative to the cast iron, in the sense that it gradually transforms, by oxidation, under the effect of the electrochemical cell formed by the cast iron, the alloy and the ground.

The formation of said protective layer makes it possible to protect the underlying cast iron, which may be exposed at the injuries to the layer of alloy. The bactericidal agent of the first layer 11 inhibits the action of bacteria that may be present.

Due to its arc metallization deposition, the first layer 11 is made up of solidified drops and is therefore porous. By adapting the adjustments of the metallization method governing the size of the pores and the thickness of the layer, one skilled in the art is capable of adjusting the conditions, in particular the speed, for formation of the protective layer. It has been observed that the biphasic structure of the zinc/aluminum alloy favors trapping of the fabricated products of the zinc.

The first layer 11 has a surface density of at least 200 g/m², preferably at least 350 g/m², for example approximately 400 g/m². Advantageously, the first layer 11 is deposited by heat projection, to obtain the aforementioned surface densities.

The second layer 13 is a paint made from an organic resin, for example an epoxide, dual-component resin, in an organic solvent. The second layer 13 is porous. The second layer 13 is capable of plugging the pores of the first layer 11 as well as regulating the speed of the electrochemical reactions that occur in the environment of the piping member.

The paint is for example formulated from components on the positive lists of the European Union for contact with foodstuffs (European regulation no. EU 10/2011) and having, on the filing date of this patent application, regulatory approvals (for example, a French Certificate of Sanitary Compliance (ACS), or an English WRAS certificate) for products placed in contact with water intended for human consumption.

The second layer 13 advantageously comprises one or more active ingredients capable of coming into contact with water intended for human consumption, for example bactericidal agents. The bactericidal agent is for example a copper salt capable of restricting the activity of the bacteria in the ground 3. The bactericidal active ingredients advantageously have very slow migration (water, ground) once the paint has dried. The solid particles of the bactericidal agents are then encapsulated by the resin: the diffusion of the water from the outside environment through the resin leads to the ionization of those agents, which will subsequently be released into the outside environment by slow diffusion.

We will now describe a method for depositing the outer coating 9 on the piping member 7. The method comprises a step a) for depositing the first layer 11 on the piping member 7 as described above, and a step b) for depositing a second layer 13 on the first layer 11 as described above.

In step a), the first layer 11 is advantageously deposited by heat projection, preferably by electric arc.

A sufficient quantity of material is deposited to obtain a surface density of the first layer 11 of at least 200 g/m², preferably at least 350 g/m². The projection is for example done from solid wires or lined wires, depending on the availability of the alloyed zinc.

In step b), the second layer 13 is advantageously deposited on the first layer 11, while the latter is not covered with white efflorescences, i.e., with a reduced time lag between the deposition of the second layer 13 and the first layer 11.

In step b), the second layer 13 is advantageously deposited by gun without compressed air, in particular for the large surfaces, and/or with the brush, in particular for small surfaces or touchups, such that the second layer 13 advantageously has a thickness comprised between 60 μm and 150 μm when dry, for example a thickness of approximately 120 μm when dry.

The second layer 13 is advantageously at least partially deposited by gun without compressed air, the application done by gun being at carried out on a surface having a temperature comprised between 35° C. and 80° C. The surface is brought to said temperature for example by placing the piping members in a preheating oven.

### Coating Examples According to the Invention

Outer coating 9 on pipe 7 made from ductile cast iron, made up of a first metallized layer 11 deposited by electric arc, of 400 g/m² of zinc-aluminum-copper alloy at 15 wt % of aluminum and 1 wt % of copper, and a second layer 13 made up of a paint made from an epoxide, dual-component resin, in an organic solvent, the second layer 13 having a thickness of 120 μm when dry.

The paint was applied after preheating the pipe 7 coated with the first layer 11 in an oven at 80° C.

The paint made from epoxide resin advantageously includes a bactericidal agent, for example a copper salt, in order to restrict the activity of the bacteria from the ground 3 at the outer coating 9.

According to a second example, the first layer 11 includes a bactericidal agent, for example copper, in order to restrict the activity of the bacteria from the ground 3 at the outer coating 9. The second layer 13 in this example has no bactericidal agent.

According to a third example, the first layer 11 has no bactericidal agent and the second layer 13 includes a bactericidal agent, for example a copper salt, in order to restrict the activity of the bacteria from the ground 3 at the outer coating 9.

Owing to the features of the first layer 11 and the second layer 13 described above, the outer coating 9 provides even more effective corrosion protection for the piping member 7, in particular in a corrosive ground 3 having strong bacterial activity. In fact, the second layer 13 very effectively plugs the pores of the first layer 11 while making it possible to regulate the speed at which the sacrificial alloy is consumed. Furthermore, the outer layer 9 has a very competitive cost, owing to its composition and its application method.

Furthermore, the operations to coat the piping member 7 are made easier, since it is possible to deposit the same coating 9 on zones designed to be in contact only with the corrosive ground 3 and zones that may be found in contact with water 5 intended for human consumption.

1. An outer coating for an underground piping member made from iron, in particular cast iron, the outer coating having a first porous layer and a second porous layer positioned on the first layer and capable of plugging the pores of the first layer, wherein:
the first layer comprises substantially pure zinc or an alloy or pseudo-alloy of zinc, the alloy or pseudo-alloy comprising at least 50 wt % zinc,
the second layer comprises a paint with a base of at least one organic resin, the paint being either single-component in an organic solvent or co-solvent, or dual-component, and
at least one among the first layer and second layer comprises a bactericidal agent.

2. The outer coating according to claim 1, wherein the first layer comprises at least one bactericidal agent taken from the list consisting of copper, silver, and a mixture of copper and silver, said copper, said silver, and said mixture of copper and silver respectively being at concentrations comprised between 0.1 wt % and 5 wt %.

3. The outer coating according to claim 1, wherein the second layer comprises at least one bactericidal agent capable of coming into contact with water intended for human consumption.

4. The outer coating according to claim 1, wherein the first layer has a surface density of at least 200 g/m².

5. The outer coating according to claim 1, wherein the organic resin of the second layer is chosen from among acrylic, epoxide, polyurethane, bituminous, vinyl resins and mixtures thereof.

6. The outer coating according to claim 1, wherein the paint contains a solvent chosen from among organic solvents, water, and mixtures thereof, the solvent representing between 20 wt % and 60 wt %, of the paint, and the organic resin representing between 20 wt % and 70 wt % of the paint.

7. A coated piping member made from iron, designed to be buried, comprising an outer coating according to claim 1.

8. A method for depositing an outer coating according to claim 1 on a piping member made from iron designed to be buried, the method comprising the following steps:
a) deposition of the first layer on the piping by metallization, and
b) deposition on the first layer, not covered with white efflorescences, of the second layer.

9. The method according to claim 8, wherein step b) for depositing the second layer is done by gun, and/or using a brush or roller, such that the second layer has a thickness comprised between 60 μm and 150 μm when dry.

10. The method according to claim 8, wherein step b) for depositing the second layer is at least partially done by gun with no compressed air, the application done by gun being performed on a surface having a temperature comprised between 35° C. and 80° C.

11. The outer coating according to claim 1, wherein the alloy or pseudo-alloy comprises between 0.5 wt % and 40 wt % aluminum.

12. The outer coating according to claim 2, wherein said mixture of copper and silver is at concentrations comprised between 0.5 wt % and 3 wt %.

13. The outer coating according to claim 3, wherein the second layer comprises copper, silver, or salts thereof.

14. The outer coating according to claim 3, wherein said copper, silver, or salts thereof are respectively at concentrations comprised between 0.1 wt % and 5 wt %.

15. The outer coating according to claim 4, wherein the surface density of the first layer is at least 350 g/m².

16. The outer coating according to claim 6, wherein the solvent represents between 30 wt % and 50 wt % of the paint.

17. The outer coating according to claim 6, wherein the organic resin represents between 25 wt % and 45 wt % of the paint.

18. The method according to claim 8, wherein said deposition of the first layer is performed by electric arc metallization.
